(19) United States
(12) Patent Application Publication
(10) Pub. No.: US 2013/0339334 A1
(43) Pub. Date: Dec. 19, 2013

(54) PERSONALIZED SEARCH ENGINE RESULTS

(71) Applicant: MICROSOFT CORPORATION, Redmond, WA (US)

(72) Inventors: Jared Brown, Kirkland, WA (US); Lee Dicks Clark, Seattle, WA (US); Sherry Pei-Chen Lin, Redmond, WA (US); Houston Wong, Kirkland, WA (US); Nathan Eldon Nesbit, Duvall, WA (US); Elliot William Kirk, Bellevue, WA (US); Jason Deakins, Kirkland, WA (US); Joanne Cunningham, Redmond, WA (US); Prateep Gopalkrishnan, Seattle, WA (US)

(73) Assignee: Microsoft Corporation, Redmond, WA (US)

(21) Appl. No.: 13/656,481

(22) Filed: Oct. 19, 2012

Related U.S. Application Data
(60) Provisional application No. 61/660,224, filed on Jun. 15, 2012.

(51) Int. Cl. G06F 17/30

(52) U.S. Cl. 707/706; 707/E17.108

(57) ABSTRACT

A user can selectively customize what data is provided to a search engine to influence a degree of personalization of search results. Personalized search engine results can thereby be provided to one or more applications on a client device, such as a mobile phone. The data provided to the search engine can include any of a variety of user preferences stored on the client device (e.g., music, music ratings, search queries, search results selected, etc.), or other user information, such as current location or the location of the user when applications were downloaded. Social networking websites can also be used for supplying data to the search engine.

### CROSS REFERENCE TO RELATED APPLICATIONS

This application claims priority from U.S. Provisional Application No. 61/660,224, filed Jun. 15, 2012, which is incorporated herein by reference in its entirety.

### FIELD

The present application relates generally to searching, and, particularly, to personalizing search engine results.

### BACKGROUND

The amount of information and content available on the Internet continues to grow at a fast rate. Given the vast amount of information, search engines have been developed to facilitate searching for electronic documents. In particular, users may search for information and documents by entering search queries comprising one or more terms that may be of interest to the user. After receiving a search query from a user, a search engine identifies documents and/or web pages that are relevant based on the search query. Because of its utility, the process of finding relevant web pages and documents for user issued search queries, has arguably become the most popular service on the Internet today.

### SUMMARY

According to various embodiments disclosed herein, a user can selectively customize what data is provided to a search engine to influence a degree of personalization of search results. Personalized search engine results can thereby be provided to one or more applications on a client device, such as a mobile phone. The data provided to the search engine can include any of a variety of user preferences stored on the client device (e.g., music, music ratings, search queries, search results selected, etc.), or other user information, such as current location or the location of the user when applications were downloaded. Social networking websites can also be used for supplying data to the search engine.

In one embodiment, based on the user selections, tokens can be sent to a search engine. The tokens can include information needed by the search engine to access the data. For example, a token may include an application name, an address of the data and/or authorization information (e.g., user id and/or password or account number) needed to access the data. In response to the token, the search engine can send the client device an anonymous database key. When sending a search request, the client device can pass the search terms together with the anonymous database key, which can then be used by the search engine to access the one or more tokens in order to retrieve the data. Thus, by using the database key, the search engine anonymously associates tokens to the user. The search request can work for not only entered queries, but implicit searches as well. For example,

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the invention will become more apparent from the following detailed description, which proceeds with reference to the accompanying figures.

### BRIEF DESCRIPTION OF THE DRAWINGS

FIG. 1 is flowchart of a method for user selection of data sources to be used by a search engine.

FIG. 2 is an example user interface that allows user control of personalization data accessible by a search engine.

FIG. 3 shows a plurality of applications that can access a personalization options application for allowing user control of personalization data accessible by a search engine.

FIG. 4 is an example embodiment of multiple applications receiving search result information.

FIG. 5 shows an example embodiment of data being retrieved from multiple sources, in addition to the client device receiving the personalized results.

FIG. 6 is a flowchart of an embodiment for user selection of data sources accessible by a search engine.

FIG. 7 is an embodiment showing a client device that can be used to implement any of the embodiments described herein.

FIG. 8 is another embodiment showing a client device that can be used to implement any of the embodiments described herein.

FIG. 9 is an exemplary database structure that can be used with a search engine.

FIG. 10 is an exemplary mobile device that can be used in any of the described embodiments.

FIG. 11 is an exemplary cloud environment that can be used with embodiments described herein.

### DETAILED DESCRIPTION

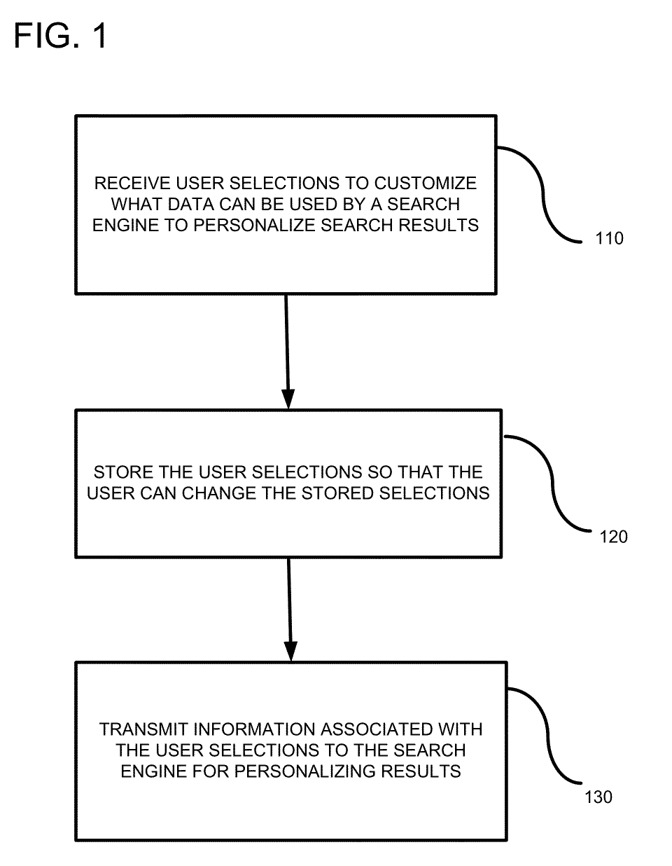

FIG. 1 is a flowchart of a method for personalizing a search performed by a search engine. In process block 110, user selections can be received to customize data used by a search engine in performing a search. For example, a user can control (selectively opt-in and opt-out) of what data can be accessed by or sent to a search engine in performing a personalized search. Thus, if the user so chooses, the search engine can take into account data from multiple devices and/or services to obtain a holistic picture of what the user does and does not prefer across several domains. In process block 120, the user selections can be stored so that they can be changed by the user at any time. For example, the user can access a graphical user interface and the selections previously made can be displayed as checked boxes, sliders, or any other selectable user interface elements. The user can then change the previously stored settings and the new settings can be stored for later use. In process block 130, information associated with the user selections can be transmitted to the search engine for personalizing results. The information can be in the form of tokens, which can include an application name, address, and/or authentication information. Thus, the token can include information needed by the search engine to retrieve (i.e., pull) the data from the client device, multiple associated client devices, or third-party servers. Alternatively, the information can be the data itself to be used in the personalization of search results. Typically, the transmission of information is sent in an initialization phase, separate from and before any search requests. For example, the transmission of information can be in response to the user customization selections in the user interface. The information can then be used in multiple, subsequent searches, as further described below. The transmission of information can also be made at the same time as the search request (e.g., the user's current location).

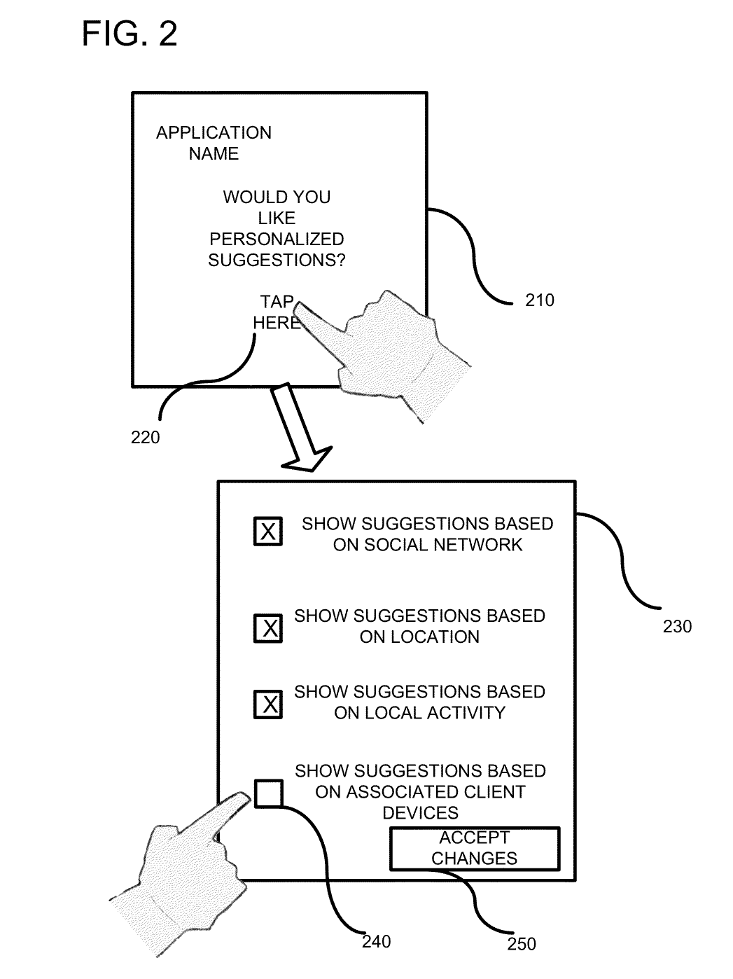

FIG. 2 shows an example graphical user interface that can be used to customize data used by a search engine to personalize search results. In user interface display 210, a page of an application invites a user to personalize suggestions through selection (e.g., clicking, tapping, etc.) at a particular location on the page, as shown at 220. Once the user makes the selection, an application page 230 can be displayed wherein the user can select and deselect different customization options. The customization options allow the user to selectively enable and disable data sources to be supplied or accessed by a search engine when performing a search. For example, FIG. 2 shows a user selecting check boxes, such as check box 240. The illustrated check boxes include allowing access to data stored in a social network (e.g., a third-party server), location information associated with the client device (e.g., GPS coordinates when certain events occur), local activity (e.g., stored user preferences), and associated client devices (e.g., other client devices linked through a common access credentials.) Other data sources and information can also be used. Once the user is satisfied with the selections, an accept changes button 250 can be selected. As further described below, in some embodiments, selection of the accept changes button 250 can be a trigger for sending updated customization settings to a search engine for subsequent searches. Thus, the customization settings can be stored on a server computer associated with the search engine and used in conjunction with a subsequent search received from the same client device. It should be understood that the illustrated user interface can easily be modified as to selections available and look and feel.

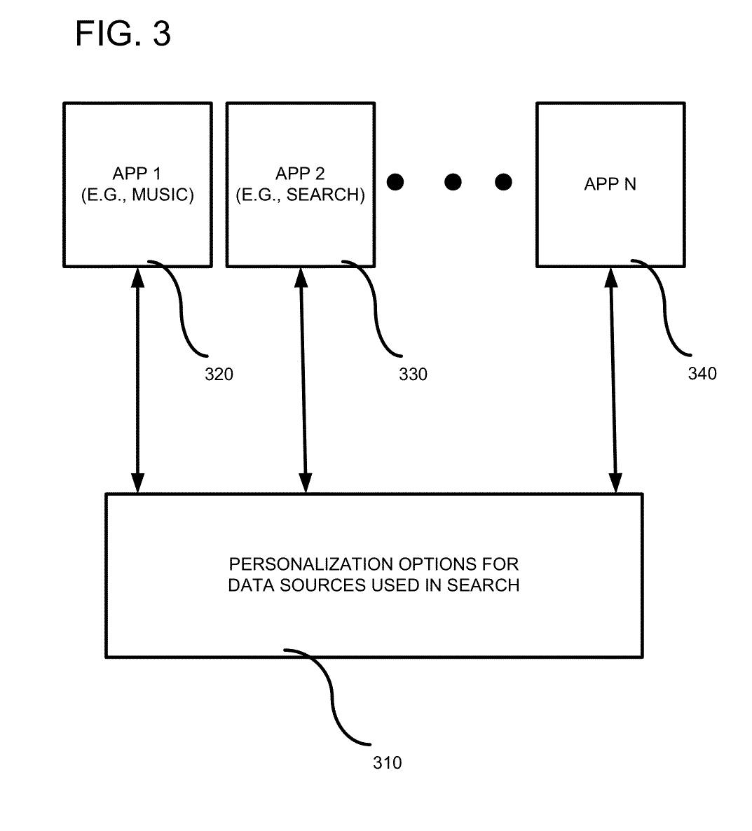

FIG. 3 is a system diagram showing a structure that can be used for allowing a user to customize data sources supplied or accessed in a search. Block 310 shows the personalized options 310 can be accessible from multiple applications 320, 330, 340 available on a client device. The applications can be any of a variety of applications, such as music, search, etc. The applications 320, 330, 340, can be separate from or integrated into an operating system on the client device. The personalization options can be part of an identity manager, described further below, and can be a separate application or part of the operating system. Using the structure of FIG. 3, a user can allow access to client data on an application-by-application basis for the purposes of personalizing searches. Thus, the user can allow data from some applications and not allow data access to other applications. For example, a user can allow music preferences to be used in searches (data associated with application 320), but not allow data to be used that is associated with application 330 (e.g., prior searches). By allowing multiple entry points into the personalization options 310, customization of data usable in a search can be controlled on an application basis. Once the user chooses to enter the personalization options, a page can be displayed (similar to FIG. 2) wherein user selectable criteria can be selected or deselected.

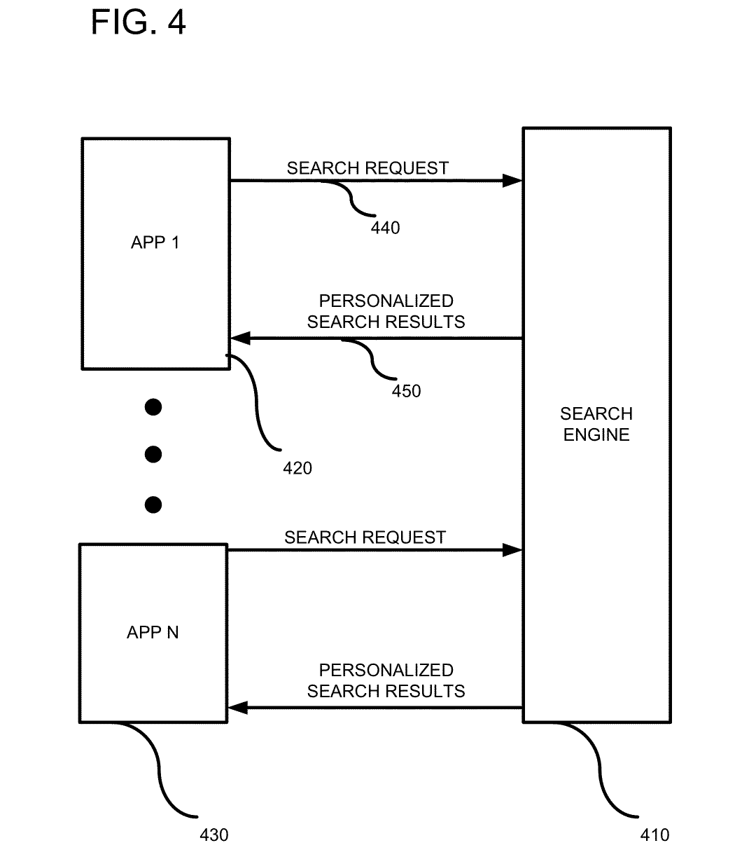

FIG. 4 is an example structure wherein a search engine 410 can be used to customize pages displayed in multiple applications 420, 430. The search engine 410 can be located on a server computer, while the applications 420, 430 are located on a client device. In order to customize content displayed in an application, each application can make a search request and receive back personalized results using the embodiments described herein. For example, a music application can display a “news section” that is updated periodically so that the user receives personalized, updated content associated with the application. Additionally, the content can be based on the previous user activity associated with the application. In one simple example, if the user had previously selected and downloaded music from a particular artist, the news section displayed to the user can be the latest news based on a search of that artist. The user need not manually enter a search term. Instead, the application can automatically send a search request (an implicit search) and receive a personalized result, as shown at 440, 450, in order to customize a page displayed to the user. Thus, in one example, an implicit search is one where the user did not send a search query, but the device sends a query (or set of queries) on the user's behalf. For example, opening an application, the user does not type in a search for “restaurants near <location>” but the application can implicitly make requests of the search server such that it can return results for queries.

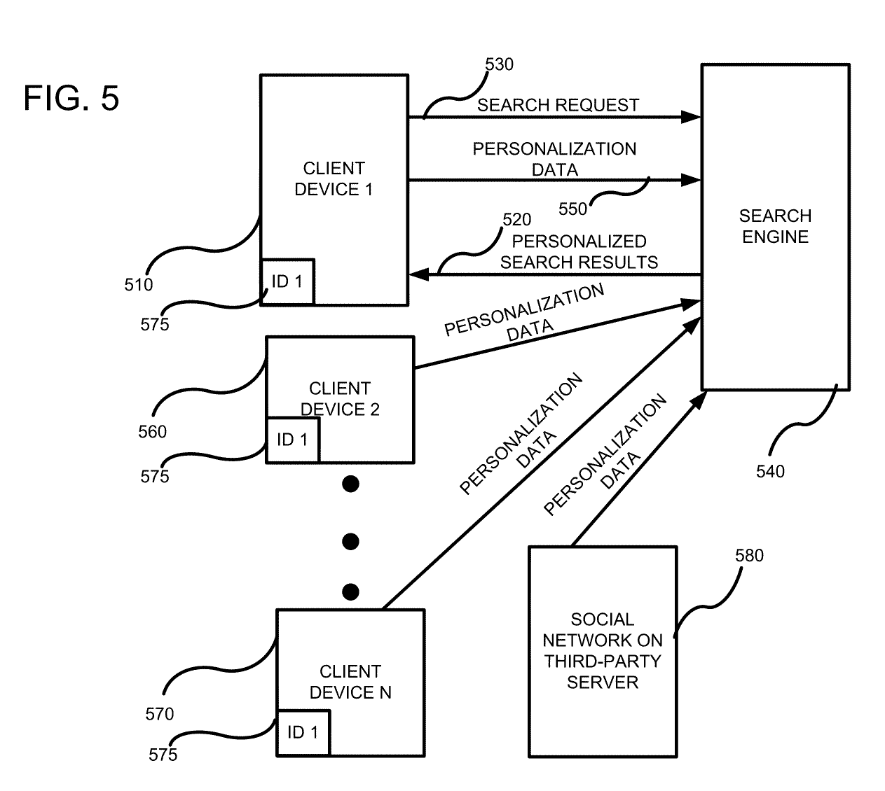

FIG. 5 shows an embodiment wherein a variety of data sources can be used by a search engine. In this example, client device 1, shown at 510, is receiving personalized search results 520 based on a search request 530. A search engine 540 can pull data from a variety of sources in order to personalize the search. However, as previously discussed, the user can selectively turn on and off which sources of data can be used. In this example, personalization data 550 can come from the client device 510 that made the search request. Additionally, other client devices 560, 570 can supply personalization data. The other client devices can have different platforms than the client device 1, but can be associated with client device 1, such as through a common anonymous identifier 575. The common identifier 575 can be a unique user identifier, which can allow access to multiple client devices using a common account. Additionally personalization data can be delivered from third-party websites, such as a social network site 580. By using data from a social networking site, parameters can be used in a search which is based on data associated with friends found in the social network site. In this way, preferences of friends can be used in formulating search results for a user of a client device. In sum, in obtaining the personalized search results 520, a variety of user selected data sources can be used in conjunction with the search, and a unique user identification can be used across platforms other than the client device.

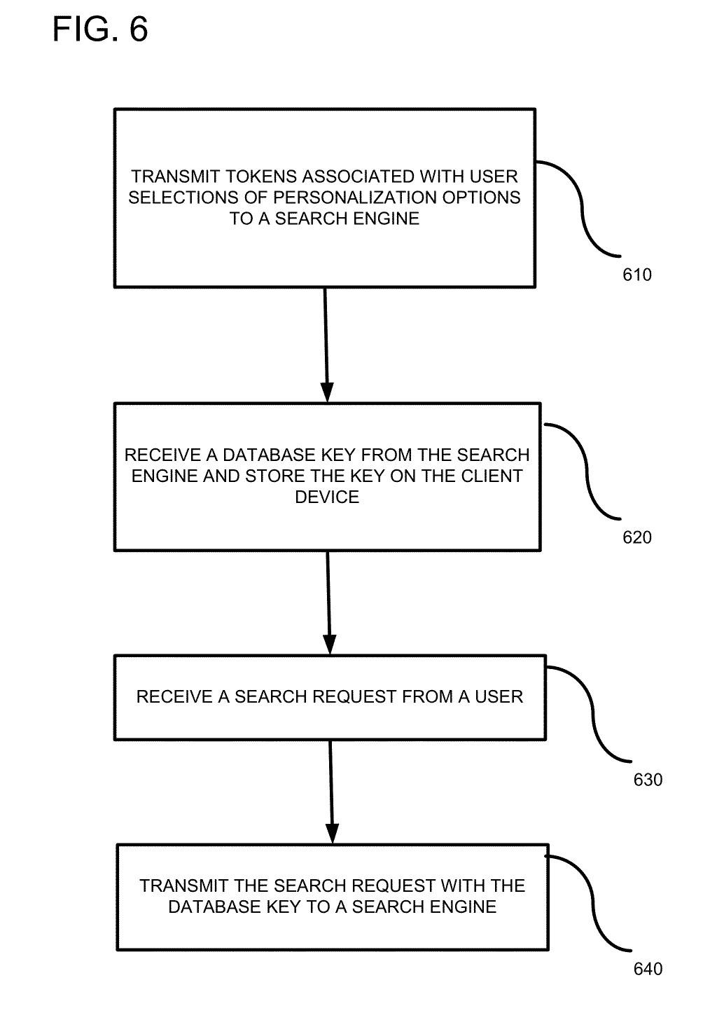

FIG. 6 is a flowchart of an embodiment that can be used to personalize search results. In process block 610, tokens associated with the user selection of personalization options can be transmitted to a search engine. A token includes information needed to access data from a data source. It can include one or more of the following fields: an application name, an address, a user id and/or a password. A separate token can be sent for each user selection of a data source. Thus, separate tokens can be associated with separate applications on a client device, or separate tokens can be associated with separate client devices and third-party sources. In process block 620, a database key can be received from the search engine in response to the transmission of tokens. The database key can be used in subsequent searches in order to access the tokens on the server computer. In this way, subsequent searches can be performed using an anonymous database key in order to secure a user's privacy. The database key can be stored on the client device so that it can be readily accessible in future searches. In process block 630, a search request can be received by a client device. For example, in a search application (i.e., a locally-stored application used for accessing a server-based search engine) can receive user input for a desired search request to be sent to a search engine. Alternatively, the search request can be an automatic request sent by an application, such as an application which the user opened. Thus, implicit or explicit search requests can be made. In process block 640, the database key can be retrieved and sent together with the search request to a search engine. The database key can then be used by the search engine to access the one or more tokens stored on the server computer. The tokens, in turn, can be used to access the data sources selected by the user. Example data includes one or more of the following: what applications were added or removed on the client device; location information of the client device when applications were downloaded; music stored on the client device; or actions taken by the client device on received search results. When performing a search, the data obtained from the data sources can be used as search parameters in the search. As such, the search engine can deliver search results that are personally relevant to the user. Additionally, by personalizing the results, different results can be provided to different users making a same search request.

In some embodiments, the client device can monitor the time a user downloaded applications and the time of searches that included location. When searches with location occurred within a recent threshold of the time that an application was downloaded, it can be inferred that the application was downloaded near where the user searched (e.g., the same city).

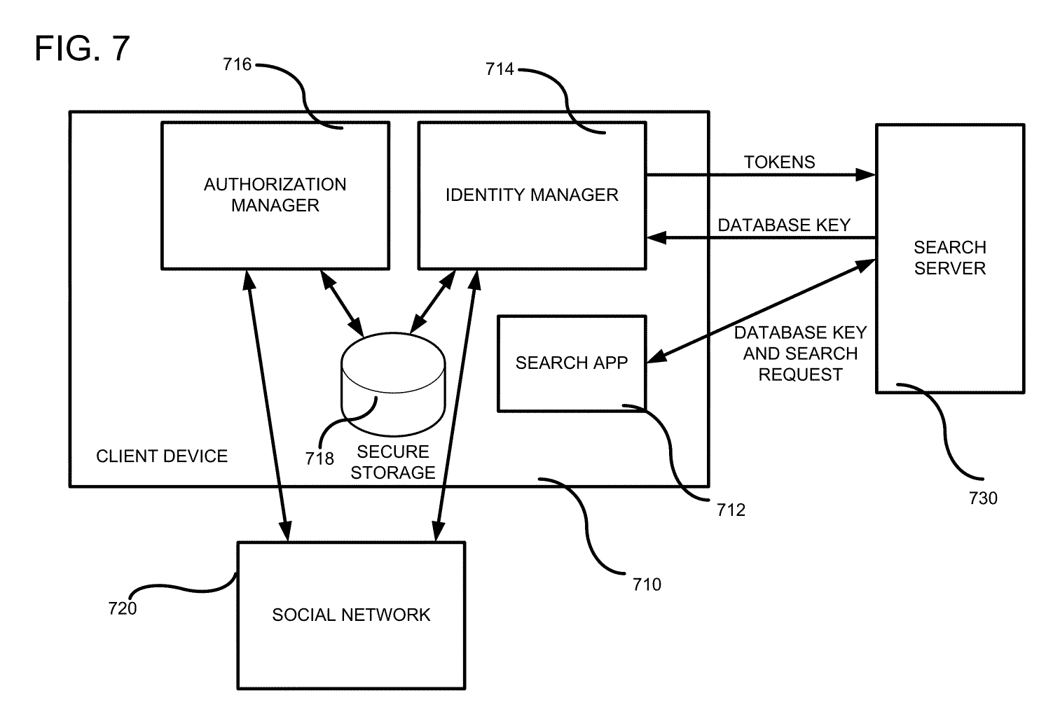

FIG. 7 is an example system diagram for implementing any of the embodiments described herein. A client device 710 can include a search application 712. The search application 712 generally includes a dialog box or other user interface element in which a user can enter a search request. The client device 710 can include an identity manager 714, an authorization manager 716, and storage 718, such as memory. The authorization manager 716 can communicate with a social network 720 to obtain a deep-link cookie with credentials for accessing data in the social network associated with the user of the client device 710. The deep-link cookie can be stored in the storage 718. If the user selects customization options such that data in the social network is available to a search server 730, then the identity manager 714 can retrieve the cookie for communicating with the social network and retrieve a token associated with the social network. The token can then be stored in local storage 718 and passed from the identity manager 714 to the search server 730. The search server 730 can store the token in association with a database key and respond to the identity manager with the database key to be used on future requests. The database key can also be stored in the local storage 718 for later use. When a user enters a search request using the search application, the search application retrieves the database key from the storage and sends it with the search request to the server 730. The server can access stored tokens on the server using the database key. In one example, using the stored token associated with the social network 720, the search server can access data associated with the user of the client device 710, such as personal data and data associated with links to friends. The data obtained by the search server from the client device and the social network can be used as parameters in a search for personalizing search results for the client.

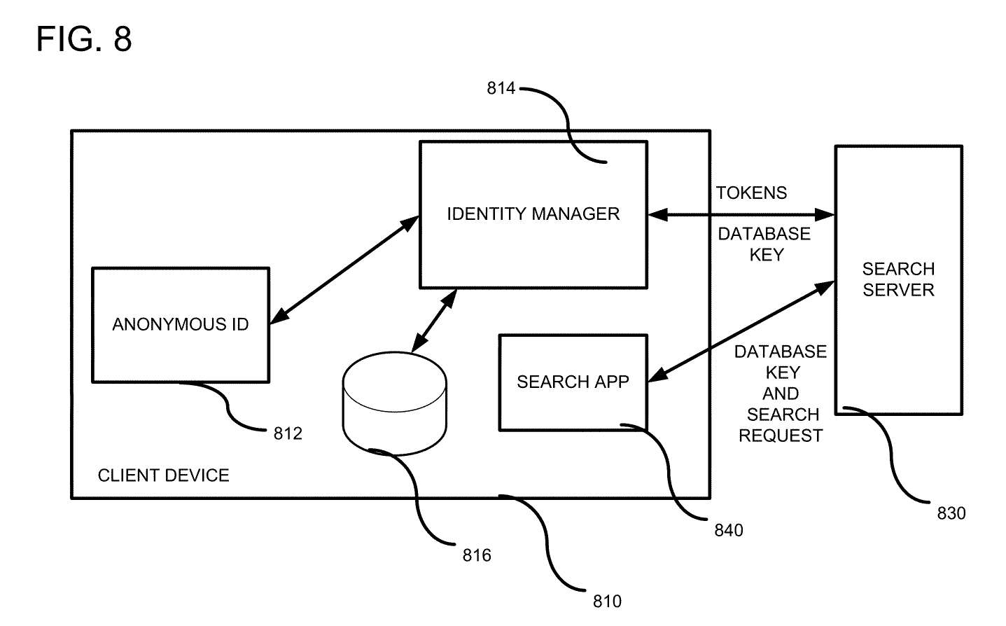

FIG. 8 shows another embodiment wherein a client device 810 has a stored anonymous identification 812. An identity manager 814 can retrieve tokens associated with different client devices and social networking sites using the anonymous ID 812, as is well understood in the art. The tokens can be stored in local storage 816. During an initialization phase, a user can customize settings as described herein to authorize a search server 830 to access one or more data sources including applications on the client device 810, associated client devices, and associated third-party servers. The tokens associated with the authorized devices can be sent by the identity manager 814 to the search server 830. The tokens can include the anonymous ID 812 so that the search server can later access authorized data. In response, a database key can be sent back to the identity manager 814, which stores the database key in storage 816 for later use by the search application 840. When a search request is made by the search application 840, the database key can be transmitted together with the search terms to the search server 830. The search server can then use the database key to access the tokens. Using the tokens the search server can access the authorized data.

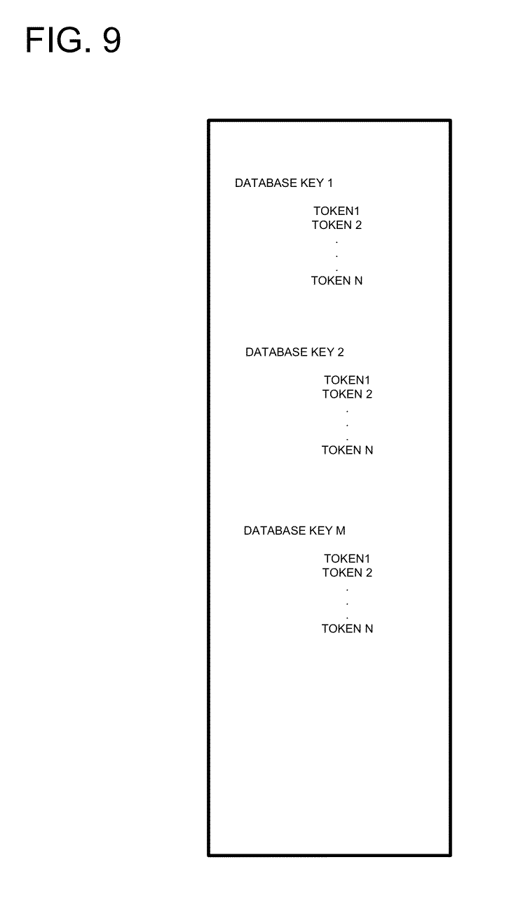

FIG. 9 is an example database structure that can be used on the search server. A plurality of database keys provide access to associated tokens. Each key has any number of desired tokens depending on the personalized settings which were selected by the user and supplied by the client device. Once the database key is returned to the server, it can access any previously supplied tokens. The tokens are then used to access applications, various clients and third party servers. The tokens can include application identifications, user credentials and/or addresses to obtain data.

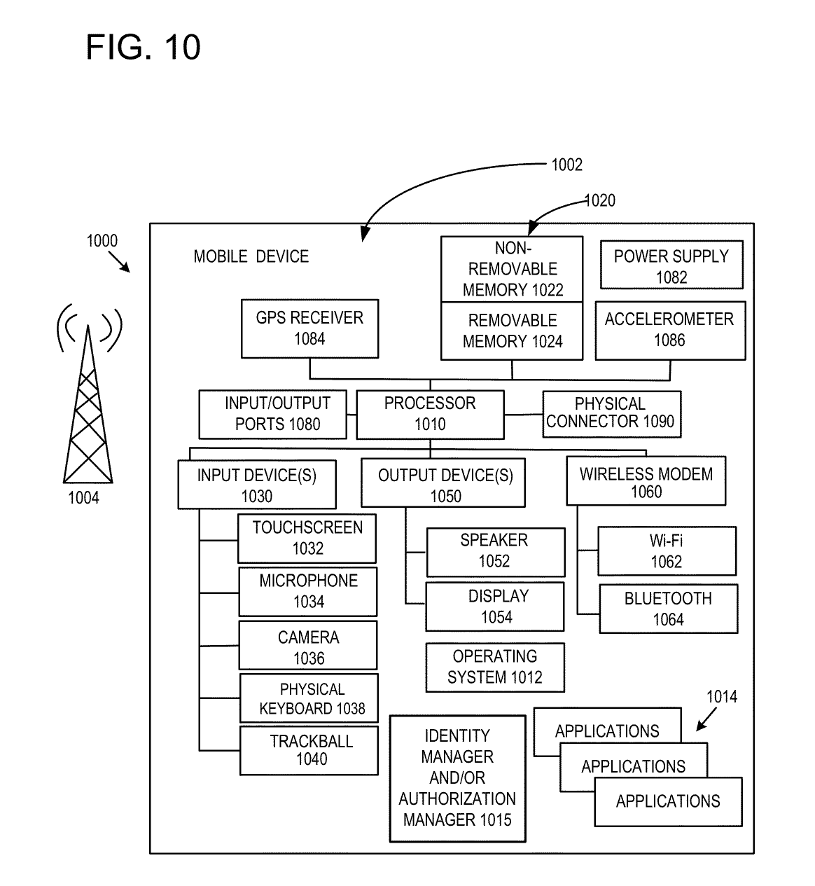

FIG. 10 is a system diagram depicting an exemplary mobile device 1000 including a variety of optional hardware and software components, shown generally at 1002. Any components 1002 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1004, such as a cellular or satellite network.

The illustrated mobile device 1000 can include a controller or processor 1010 (e.g., signal processor, microprocessor, ASIC, or other control and processing logic circuitry) for performing such tasks as signal coding, data processing, input/output processing, power control, and/or other functions. An operating system 1012 can control the allocation and usage of the components 1002 and support for one or more application programs 1014. The application programs can include common mobile computing applications (e.g., email applications, calendars, contact managers, web browsers, messaging applications), or any other computing application. An identity manager application and/or an authorization manager 1015 can be used to send tokens to a search server computer in order to allow user customization of data accessible by the server computer during searches, as described herein.

The illustrated mobile device 1000 can include memory 1020. Memory 1020 can include non-removable memory 1022 and/or removable memory 1024. The non-removable memory 1022 can include RAM, ROM, flash memory, a hard disk, or other well-known memory storage technologies. The removable memory 1024 can include flash memory or a Subscriber Identity Module (SIM) card, which is well known in GSM communication systems, or other well-known memory storage technologies, such as “smart cards.” The memory 1020 can be used for storing data and/or code for running the operating system 1012 and the applications 1014. Example data can include web pages, text, images, sound files, video data, or other data sets to be sent to and/or received from one or more network servers or other devices via one or more wired or wireless networks. The memory 1020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1000 can support one or more input devices 1030, such as a touchscreen 1032, microphone 1034, camera 1036, physical keyboard 1038 and/or trackball 1040 and one or more output devices 1050, such as a speaker 1052 and a display 1054. Other possible output devices (not shown) can include piezoelectric or other haptic output devices. Some devices can serve more than one input/output function. For example, touchscreen 1032 and display 1054 can be combined in a single input/output device. The input devices 1030 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1012 or applications 1014 can comprise speech-recognition software as part of a voice user interface that allows a user to operate the device 1000 via voice commands. Further, the device 1000 can comprise input devices and software that allows for user interaction via a user's spatial gestures, such as detecting and interpreting gestures to provide input to a gaming application.

A wireless modem 1060 can be coupled to an antenna (not shown) and can support two-way communications between the processor 1010 and external devices, as is well understood in the art. The modem 1060 is shown generically and can include a cellular modem for communicating with the mobile communication network 1004 and/or other radio-based modems (e.g., Bluetooth 1064 or Wi-Fi 1062). The wireless modem 1060 is typically configured for communication with one or more cellular networks, such as a GSM network for data and voice communications within a single cellular network, between cellular networks, or between the mobile device and a public switched telephone network (PSTN).

The mobile device can further include at least one input/output port 1080, a power supply 1082, a satellite navigation system receiver 1084, such as a Global Positioning System (GPS) receiver, an accelerometer 1086, and/or a physical connector 1090, which can be a USB port, IEEE 1394 (FireWire) port, and/or RS-232 port. The illustrated components 1002 are not required or all-inclusive, as any components can be deleted and other components can be added.

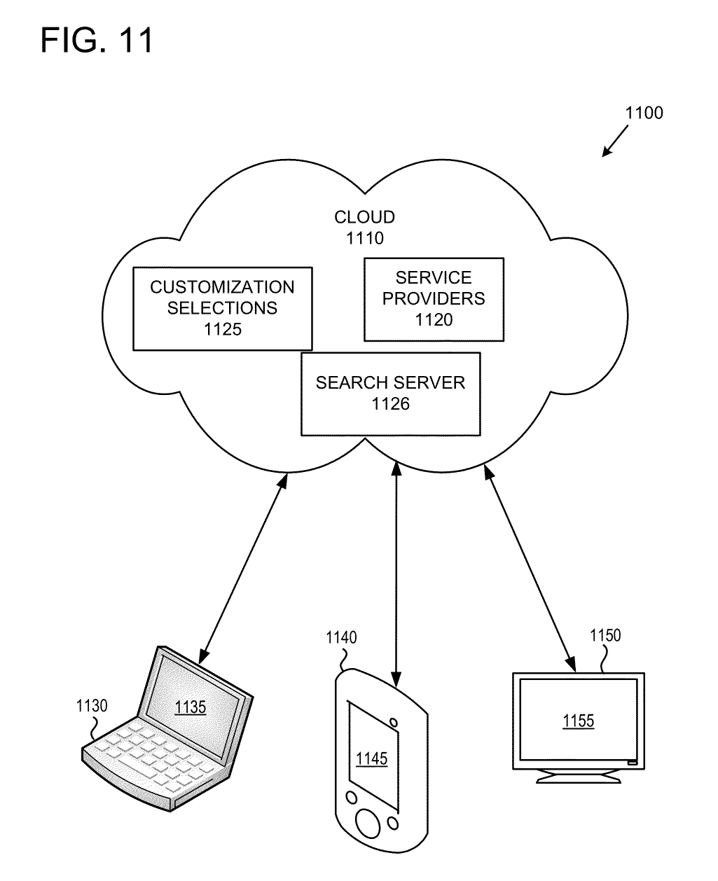

FIG. 11 illustrates a generalized example of a suitable implementation environment 1100 in which described embodiments, techniques, and technologies may be implemented.

In example environment 1100, various types of services (e.g., computing services) are provided by a cloud 1110. For example, the cloud 1110 can comprise a collection of computing devices, which may be located centrally or distributed, that provide cloud-based services to various types of users and devices connected via a network such as the Internet. The implementation environment 1100 can be used in different ways to accomplish computing tasks. For example, some tasks (e.g., processing user input and presenting a user interface) can be performed on local computing devices (e.g., connected devices 1130, 1140, 1150) while other tasks (e.g., storage of data to be used in subsequent processing) can be performed in the cloud 1110.

In example environment 1100, the cloud 1110 provides services for connected devices 1130, 1140, 1150 with a variety of screen capabilities. Connected device 1130 represents a device with a computer screen 1135 (e.g., a mid-size screen). For example, connected device 1130 could be a personal computer such as desktop computer, laptop, notebook, netbook, or the like. Connected device 1140 represents a device with a mobile device screen 1145 (e.g., a small size screen). For example, connected device 1140 could be a mobile phone, smart phone, personal digital assistant, tablet computer, or the like. Connected device 1150 represents a device with a large screen 1155. For example, connected device 1150 could be a television screen (e.g., a smart television) or another device connected to a television (e.g., a set-top box, personal computer, or gaming console) or the like. One or more of the connected devices 1130, 1140, 1150 can include touchscreen capabilities. Touch screens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1100. For example, the cloud 1110 can provide services for one or more computers (e.g., server computers) without displays.

Services can be provided by the cloud 1110 through service providers 1120, or through other providers of online services (not depicted). For example, cloud services can be customized to the screen size, display capability, and/or touchscreen capability of a particular connected device (e.g., connected devices 1130, 1140, 1150). Customization selections 1125 can be provided by the user to personalize searching across multiple client devices, as already described. Thus, a user needs to only update the customization selections once to update a plurality of client devices. A search server 1126 can also be included in the cloud 1110, as described herein, and can be a same server or a separate server that stores the customization selections 1125.

In example environment 1100, the cloud 1110 provides the technologies and solutions described herein to the various connected devices 1130, 1140, 1150 using, at least in part, the service providers 1120. For example, the service providers 1120 can provide a centralized solution for various cloud-based services. The service providers 1120 can manage service subscriptions for users and/or devices (e.g., for the connected devices 1130, 1140, 1150 and/or their respective users).

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of personalizing a search performed by a search engine, comprising:
receiving, on a client device, user selections to customize what data can be used by a search engine to personalize search results to the client device;
storing the user selections so that the user can change the stored user selections of what data can be used by the search engine; and
in response to the user selections, transmitting information associated with the user selections to the search engine for personalizing the search results.

2. The method of claim 1, wherein transmitting information includes transmitting one or more tokens to the search engine, the one or more tokens providing information needed to access the data.

3. The method of claim 2, further including receiving from the search engine a database key used to access the one or more tokens.

4. The method of claim 3, further including receiving a search request from a user, and transmitting the database key, together with the search request, to the search engine.

5. The method of claim 2, wherein the token includes an anonymous identifier that can be used to access data across multiple platforms.

6. The method of claim 1, wherein the data includes data from a third-party social networking website.

7. The method of claim 1, wherein the data includes one or more of the following: what applications were added or removed on the client device; location information of the client device when applications were downloaded; music stored on the client device; or actions taken by the client device on received search results.

8. The method of claim 1, wherein the data is associated with applications or services other than the search engine.

9. The method of claim 1, the transmitting information occurs separate from and before a search request is made by a user.

10. The method of claim 1, wherein personalizing search results means providing different results to different users making a same search request.

11. The method of claim 1, further including transmitting data associated with applications, other than a search application, to the server computer to be used as search parameters.

12. The method of claim 1, wherein storing the user selections includes storing the user selections in a memory on the client device.

13. The method of claim 1, wherein receiving user selections includes accessing a search personalization options application, which is accessible from two or more applications, on the client device, and displaying a page with user selectable criteria.

14. The method of claim 1, further including using a unique user identification, which is used across platforms other than the client device,

15. A computer-readable storage storing instructions thereon for executing a method of personalizing a search, the method comprising:
from a client device, transmitting tokens, associated with user selections of personalization options, to a search engine;
receiving a database key from the search engine and storing the database key on the client device;
receiving, on the client device, a search request for a search to be made by the search engine;
transmitting the search request together with the database key to the search engine.

16. The method of claim 15, further including storing the tokens using a server computer associated with the search engine, the tokens being accessible using the database key.

17. The method of claim 15, further including receiving the search request together with the database key, accessing the tokens using the database key, using the tokens to access data associated with the client device, and searching using the search request and the accessed data to personalize results.

18. The method of claim 15, further including receiving, on the client device, and, and, in response to the search request, search results that are personalized using data obtained from applications, other than a search application, stored on the client device.

19. A system for personalizing a search performed by a search engine, comprising:
an identity manager for transmitting one or more tokens to a search engine, the tokens associated with personalization options selected by a user;
storage in communication with the identity manager, the storage containing a database key received by the identity manager from the search engine; and
a search application for interfacing to the search engine, the search application for receiving a search request from the user and submitting the search request to the search engine, together with the database key retrieved from the storage.

20. The system of claim 19, wherein the token includes an anonymous identifier that can be used to access data across multiple platforms.
